(19) United States
(12) Patent Application Publication
(10) Pub. No.: US 2012/0087625 A1
(43) Pub. Date: Apr. 12, 2012

(54) FIBER PREFORM AND METHOD FOR MANUFACTURING THEREOF

(76) Inventors: Qingrong HAN, Wuhan (CN); Chen YANG, Wuhan (CN); Yongtao LIU, Wuhan (CN); Jie LUO, Wuhan (CN); Matai RADJJ, Wuhan (CN)

(21) Appl. No.: 13/327,736

(22) Filed: Dec. 15, 2011

Related U.S. Application Data
(63) Continuation of application No. PCT/CN2010/070774, filed on Feb. 26, 2010.

(30) Foreign Application Priority Data
Jun. 23, 2009 (CN) 200910062805.8

(51) Int. Cl. G02B 6/028; C03B 37/027; C03B 37/018; B32B 17/02; C03B 37/075

(52) U.S. Cl. 385/124; 428/384; 65/397; 65/435

(57) ABSTRACT

A fiber preform, including: a fiber core rod and an outer cladding layer. The ratio of the diameter of the fiber core rod to the diameter of the core layer thereof is 2.1-2.8. The fiber core rod and a small fluorine-doped quartz glass tube are melted to form a core rod assembly. The ratio of the diameter difference between the core rod assembly and the fiber core rod to the diameter of the core layer is 0.5-2.2. The relative refractive index difference of fluorine-doped quartz glass relative to purified quartz glass Δ_{F} is −0.20% to −0.35%. The core rod assembly is arranged with a large purified quartz glass tube, or directly deposited with a SiO₂ glass cladding layer. A ratio of an effective diameter of the fiber preform to the diameter of the core rod assembly is 2.0-5.6. Methods for manufacturing the preform and a fiber are also provided.

### CROSS-REFERENCE TO RELATED APPLICATIONS

This application is a continuation of International Patent Application No. PCT/CN2010/070774 with an international filing date of Feb. 26, 2010, designating the United States, now pending, and further claims priority benefits to Chinese Patent Application No. 200910062805.8 filed Jun. 23, 2009. The contents of all of the aforementioned applications, including any intervening amendments thereto, are incorporated herein by reference.

### BACKGROUND OF THE INVENTION

1. Field of the Invention

The invention relates to the category of the optical communication technology, and more particularly to a fiber preform, a manufacturing method thereof, and a manufacturing method of a fiber using the preform.

2. Description of the Related Art

In the process of manufacturing fibers, because of the existence of the absorption peak (it is also known as “water peak”) caused by the hydroxyl (OH) within 1360-1460 nm, the usage of the fibers at the wave range is limited. To apply the fibers in the whole wave range, the water peak within that range shall be eliminated. Thus, the fibers can offer an available wave range with a width as wide as 400 nm. In accordance with the specification of ITU-T G.652.C/D, the fibers, having the attenuation less than the specified value of 1310 nm within the range of 1383±3 nm, are generally called “low water peak fibers” or “zero water peak fibers”.

Fiber to the x (FTTx) has become a hot spot for optical network construction in recent years and people have conducted deep research on various fibers that might be applicable to the FTTx. At present, the commonly used fibers for network connections are single-mode fibers. With the wide applications of single-mode fibers with a low water peak, the bend-insensitive fibers with a low water peak have attracted more and more attention. Since the bending radius of conventional fibers with a low water peak (in conformity with ITU-T G.652C/D) is generally 30 mm, laying such fibers indoors or in narrow spaces is greatly restricted, especially the ones with long wavelength (U wave range: 1625-1725 nm). For this reason, it is required to design and develop a fiber with anti-bending properties to satisfy the FTTH installation and the usage requirements of long wavelength. In December 2006, ITU-T came up with a new fiber standard (G.657 fiber): Characteristics of a bending loss insensitive single mode optical fiber and cable for the access network. Thus, developing single-mode fibers with a low water peak and anti-bending properties is of great significance for promoting the development of the FTTx technology.

There are various solutions in the prior art to reduce the additional bending losses of fibers, for example, to reduce the mode field diameter of fibers to reduce the MAC value (the ratio of the mode field diameter of fibers at 1550 nm to the effective cut-off wavelength). However, when the mode field diameter is reduced, the connection performance of the conventional G.652 fibers will be affected and the launching power will be reduced. An effective way at present is to add a depressed cladding layer around an inner cladding layer of a fiber to reduce the additional bending losses. The depressed cladding layer is designed by means of adding fluorine.

There are four conventional methods to manufacture a fiber preform: modified chemical vapor deposition (MCVD), plasma chemical vapor deposition (PCVD), outside vapor deposition (OVD), and vapor axial deposition (VAD), in which the MCVD and PCVD methods belong to an inner tube method which involves an outer depressed cladding layer. Thus, it is difficult to make a large-sized preform (with a diameter over 100 mm) due to the limit of the tubes. When OVD and VAD methods are applied, it is required to make a fluorine-doped cladding layer in the process of depositing a core layer and an inner cladding layer. However, the process is difficult to control and the refractive index profile cannot be effectively controlled due to dispersion of fluorine during the sintering process. A practical production method is to first deposit a core rod including a cladding layer with a certain thickness, followed by dehydration and sintering, and then to deposit a fluorine-doped cladding layer on the glass core rod. The fluorine can be directly added during the deposition process or during the sintering process. As the OVD and VAD methods both belong to a flame (H₂/O₂) hydrolysis method, the deposits have to be directly exposed to the hydrogen/oxygen flame (H₂/O₂) when deposition occurs on the glass core rod. Thus, a large amount of hydroxyl (OH) produced from the H₂/O₂ flame will spread into the core layer, resulting in an increase in the water peak attenuation of the fibers; therefore, the cladding layer around the glass core rod shall be thick enough to prevent the OH from spreading inwards. However, if the cladding layer is too thick, the fluorine-doped cladding will be far from the core layer, and therefore the anti-bending performance of the fibers cannot be improved.

In addition, mechanical connections are usually used for fibers for network access and the fibers are required to have a better core/cladding concentricity so as to lower the connection losses. Thus, it is urgent to develop an anti-bending fiber which meets the specifications of both G.652.D and G.657 fibers and has the same manufacturing costs as the G.652.D fibers.

### SUMMARY OF THE INVENTION

In view of the above-described problems, it is one objective of the invention to provide a fiber preform that features anti-bending properties and a low water peak.

It is another objective of the invention to provide a method for manufacturing a fiber preform that features anti-bending properties and a low water peak.

It is still another objective of the invention to provide a method for manufacturing a fiber using a fiber preform that features a large size, low cost, anti-bending properties, and a low water peak.

For the purpose of the invention, related terms are defined below:

Fiber preform: it refers to a glass rod or a combination of a core layer and a cladding layer, and the radial refractive index thereof conforms to the requirement for designing a fiber; the glass rod or the combination can be directly manufactured into a fiber.

Fiber core rod: it refers to a prefabricated part comprising a core layer and some cladding layers.

CSA: it refers to the cross sectional area (unit: mm²).

Small tube: it refers to a fluorine-doped quartz glass tube with a small CSA in accordance with the geometric requirements.

Large tube: it refers to a purified quartz glass tube with a large CSA in accordance with the geometric requirements.

Fiber core rod with a low water peak: it refers to a core rod which can be manufactured into fibers after being covered with a purified quartz cladding layer; the resulting fibers have an attenuation of no more than 0.4 dB/km at the water peak (1383±3 nm).

Core rod assembly: it refers to a prefabricated part formed after melting a fiber core rod together with a small tube (as shown in FIG. 2: 1-core layer; 2-cladding layer; 3-small tube);
a: the diameter of the core layer of the fiber core rod (unit: mm);
b: the diameter of the fiber core rod (unit: mm); and
c: the diameter of the core rod assembly (unit: mm).

Bow: it refers to the average value of the sum of the minimum and maximum deviating values of the rod center from a rotating axis within a unit length, when a rod revolves around a central shaft for one circle (unit: mm/M).

Relative refractive index difference:

$$Δ \% = [ \frac{( {n}_{1}^{2} - {n}_{0}^{2} )}{2 {n}_{1}^{2}} ] \times 100 \% ,$$

wherein, n₁ and n₀ represent refractive indexes of two types of glass materials, respectively.

RIC process: it refers to a manufacturing process of a large-sized fiber preform by inserting a core rod assembly into a large tube after processing the core rod assembly and the big tube (comprising tapering process, elongation, corrosion, wash, and desiccation and so on).

Core/cladding concentricity error: it refers to the distance between the center of circle of a fiber core layer and the center of circle of a fiber (unit: μm).
d: it refers to the effective diameter of a fiber preform, i.e., for a solid preform, it refers to the outer diameter; for a RIC preform,

$$d = \sqrt{{( CSA of the large sleeve tube + CSA of core rod assembly )}^{*} 4 / π } ( unit \text{:} mm )$$

Amount of doped fluorine (Δ_{F}): it means a relative refractive index difference of fluorine-doped quartz glass relative to purified quartz glass.

Gap between a core rod assembly and a big tube (Gap): it refers to the unilateral distance between the core rod assembly and the big tube, i.e. Gap=[inner diameter of big tube (ID)−outer diameter of core rod assembly (c)]/2.

OVD process: it is a process to deposit SiO₂ glass to a desired thickness on the surface of a core rod using an outside vapor deposition and sintering process.

VAD process: it is a process to deposit SiO₂ glass to a desired thickness on the surface of a core rod using a vapor axial deposition and sintering process.

APVD (Alcatel Plasma Vapor Deposition) process: it is a process to deposit SiO₂ glass to a desired thickness by melting a natural or synthetic quartz powder on the surface of a core rod using a high frequency plasma flame.

Bare fiber: it refers to a glass fiber without a coating layer inside.

To achieve the above objective, in accordance with one embodiment of the invention, there is provided a fiber preform, comprising: a fiber core rod with a low water peak, and an outer cladding layer; wherein a ratio b/a of a diameter of the fiber core rod to a diameter of a core layer thereof is 2.1-2.8; the fiber core rod is covered by a small fluorine-doped quartz glass tube and the two are melted together to form a core rod assembly; a ratio (c−b)/a of a diameter difference between the core rod assembly and the fiber core rod to the diameter of the core layer is 0.5-2.2; a relative refractive index difference of the fluorine-doped quartz glass tube relative to purified quartz glass Δ_{F} is −0.20% to −0.35%, the content of hydroxyl is less than or equal to 500 ppb; the core rod assembly is arranged with a large purified quartz glass tube using a RIC process, or directly deposited with a SiO₂ glass cladding layer; and a ratio d/c of an effective diameter of the fiber preform to the diameter of the core rod assembly is 2.0-5.6.

In accordance with another embodiment of the invention, there provided is a method for manufacturing a fiber preform, comprising:
1) Manufacturing a fiber core rod with a low water peak, a ratio b/a of a diameter of the fiber core rod to a diameter of a core layer thereof being 2.1-2.8;
2) Manufacturing a small fluorine-doped quartz glass tube, a relative refraction index difference thereof (i.e. the amount of the doped fluorine Δ_{F}) relative to a purified quartz glass being from −0.20% to −0.35%, and the content of hydroxyl being less than or equal to 500 ppb;
3) Inserting one or more segments of the fiber core rod into the small fluorine-doped quartz glass tube and melting the two together to yield a core rod assembly; a ratio (c−b)/a of a diameter difference between the core rod assembly and the fiber core rod to the diameter of the core layer being 0.5-2.2; and
4) Assembling the core rod assembly with a large purified quartz glass tube using a RIC process, or directly depositing a SiO₂ glass cladding layer onto the core rod assembly to yield a fiber preform, a ratio d/c of an effective diameter of the fiber preform to the diameter of the core rod assembly being 2.0-5.6.

In a class of this embodiment, the fiber core rod with a low water peak is a single-mode fiber core rod with a low water peak.

In a class of this embodiment, the diameter a of the core layer of the fiber core rod is 6-14 mm.

In a class of this embodiment, the small fluorine-doped purified quartz glass tube is made using an OVD or VAD process, and the content of hydroxyl is less than or equal to 50 ppb.

In a class of this embodiment, the fiber core rod is inserted into the small fluorine-doped quartz glass tube, and a gap formed therebetween is 0.5-1.5 mm; the core rod assembly has a bow less than or equal to 2 mm/m.

In a class of this embodiment, during the RIC process, a wall thickness of the large purified quartz glass tube is more than or equal to 30 mm; the core rod assembly is fixed in the center of the large tube and concentric with the large tube, a gap formed between the core rod assembly and the inner hole of the large tube is less than or equal to 2 mm, preferably less than or equal to 1.5 mm, so as to maintain the core/cladding concentricity for the fiber.

In a class of this embodiment, a process for directly depositing of the SiO₂ glass cladding layer comprises an OVD process, VAD process, or APVD process. With respect to the VAD or OVD process, a ratio c/a of the core rod assembly diameter to the core layer diameter is more than or equal to 4.2. With respect to the APVD method, the ratio c/a of the core rod assembly diameter to the core layer diameter is more than or equal to 3.5.

In a class of this embodiment, the fiber preform before being drawn has a diameter of 100-200 mm.

In another aspect, the invention provides a method for manufacturing a fiber using the fiber preform, comprising:

For the fiber preform manufactured using a RIC process, drawing the fiber preform by means of a fiber drawing furnace to yield a fiber, and during the drawing vacuumizing a gap between the core rod assembly and the large tube to maintain an internal pressure of 1,000-10,000 pa; or melting and stretching the large purified quartz glass tube and the core rod assembly by means of a tower for stretching to form a small-sized fiber preform, and during the melting and stretching vacuumizing a gap between the core rod assembly and the large tube to maintain an internal pressure of 1,000-10,000 pa, and then drawing the small-sized fiber preform to yield a fiber.

Advantages of the invention are summarized below:
1. A depressed cladding layer can be obtained by setting the small fluorine-doped quartz glass tube and controlling the amount of fluorine, and then a single-mode fiber having anti-bending properties and a low water peak is prepared;
2. The fiber preform provided by the invention can be applied in manufacturing fibers in accordance with the specifications of ITU-T G.652.D and G.657 fibers; the mode field diameter of the prepared fiber is 8.4 to 9.4 μm at 1310 nm; the attenuation is less than or equal to 0.344 dB/km at 1310 nm, less than or equal to 0.344 dB/km at 1383 nm, less than or equal to 0.214 dB/km at 1550 nm and less than or equal to 0.224 dB/km at 1625 nm. The concentricity error of the fiber core/cladding is less than or equal to 0.54; at 1625 nm, the additional bending losses is no more than 0.2 dB/circle for a bending radius of 10 mm and no more than 1.0 dB/circle for 7.5 mm; and
3. This invention can be applied to manufacture large-sized fiber preforms. The drawing length of each preform may reach a thousand kilometer, which improves the production efficiency and reduces the production costs, particularly for mass production. Moreover, the methods provided herein are not limited to the G.652 and G.657 fibers, and they are applicable to all fibers with an outer depressed ring structure such as G.655 fiber.

### BRIEF DESCRIPTION OF THE DRAWINGS

FIG. 1 is a process flow diagram for manufacturing a fiber preform and a fiber comprising the same in accordance with one embodiment of the invention;

FIG. 2 is a sectional view of a core rod assembly in accordance with one embodiment of the invention;

FIG. 3 is a sectional view of a fiber preform or a bare fiber in accordance with one embodiment of the invention;

FIG. 4 is a schematic diagram of an assembled fiber preform using a RIC process in accordance with one embodiment of the invention;

FIG. 5 is a structural representation of a refractive index profile of a core rod in accordance with one embodiment of the invention;

FIG. 6 is a relationship curve for the internal pressure in a RIC process and dynamic fatigue parameters n_{d} of a resulting fiber;

FIG. 7 is a relationship curve for a gap between a core rod assembly and a big tube and core/cladding concentricity error of a resulting fiber in accordance with one embodiment of the invention; and

FIG. 8 is a relationship curve for c/a of a core rod assembly having an outer cladding layer deposited by an OVD or APVD process and the attenuation of the water peak of a fiber in accordance with one embodiment of the invention.

### DETAILED DESCRIPTION OF THE EMBODIMENTS

For further illustrating the invention, experiments detailing a fiber preform, a manufacturing method thereof, and a method for manufacturing a fiber using the preform are described below. It should be noted that the following examples are intended to describe and not to limit the invention.

### Example 1

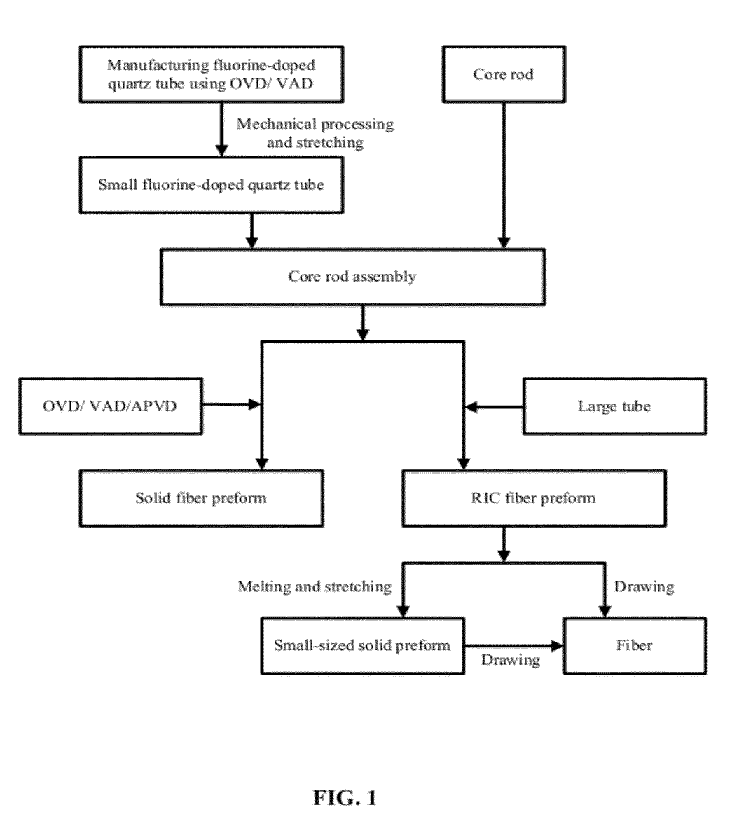

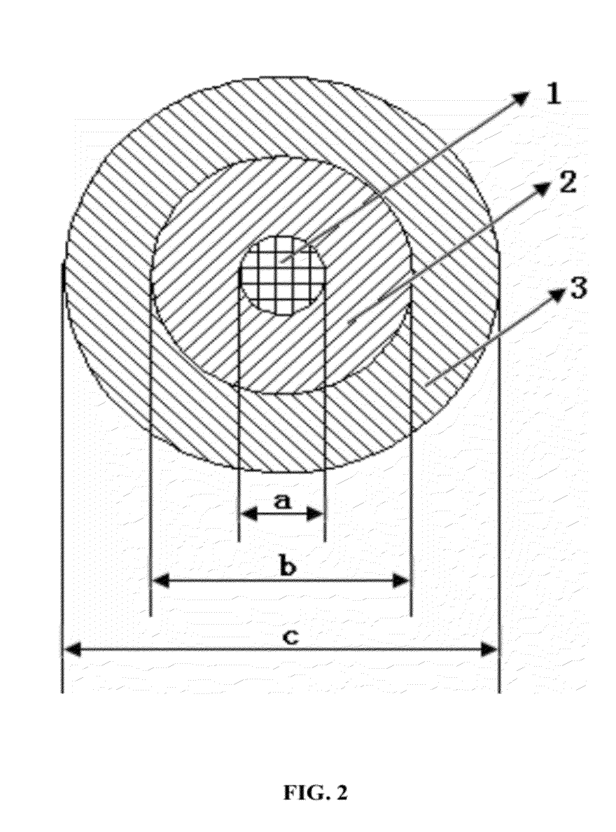

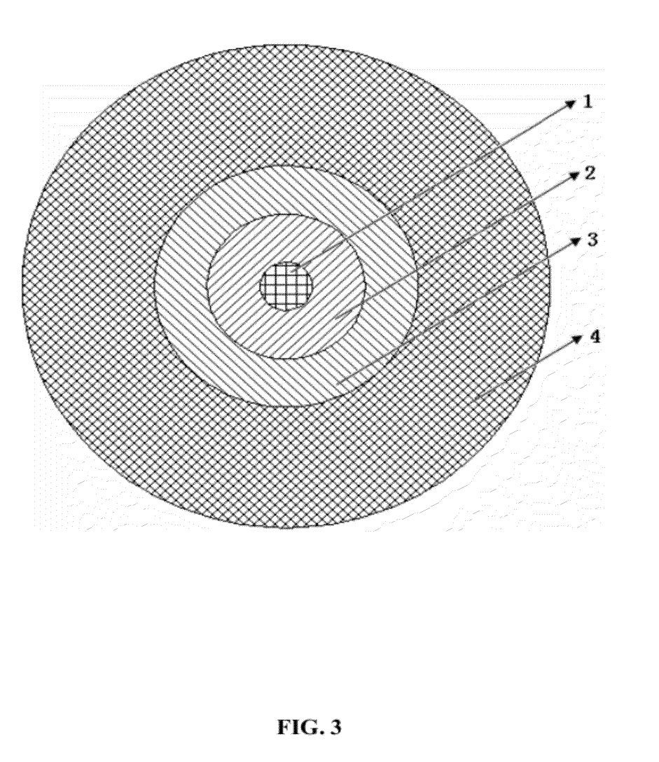

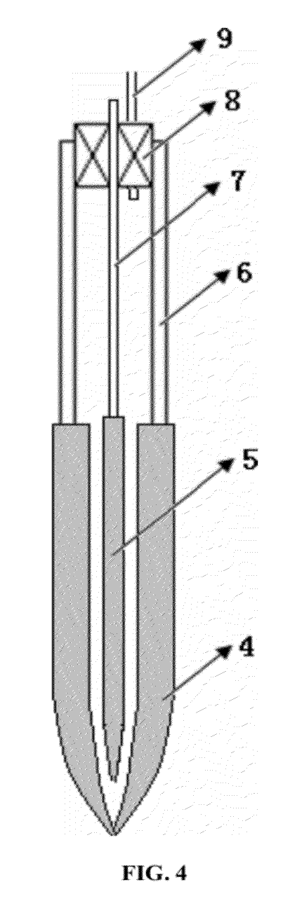

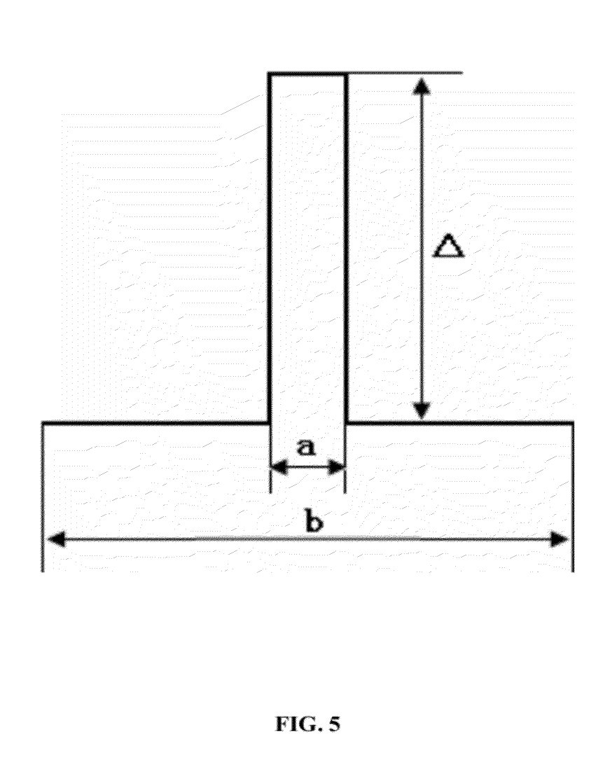

A G.652 fiber core rod with a low water peak manufactured by a PCVD process comprises a core layer 1 and a cladding layer 2. The outer diameter of a tube used is 31 mm, the wall thickness is 2 mm, and the refractive index profile of the core rod is shown in FIG. 5. A fluorine-doped quartz tube manufactured by an OVD process is stretched into a small tube 3 with a desired size after being mechanically processed. The OH content of the small fluorine-doped quartz tube is 10-500 ppb. The fiber core rod is melted together with the small tube to yield a core rod assembly 5 (as shown in FIG. 2), the surface of which is corroded by hydrofluoric acid (HF) with a corrosion thickness of 0.5-1.0 mm (single side). A quartz tube with different outer diameter (OD) and inner diameter (ID) is used as a large tube 4. The core rod assembly and the large tube are assembled into a fiber preform (as shown in FIGS. 3 and 4) using a RIC process. The core rod assembly 5 is sheathed in the large tube 4 in such a way that the center of the core rod assembly lies in the center of the large tube. The upper end of the large tube is coupled with an extension tube 6. The upper end of the core rod assembly is coupled with an extension rod 7. A RIC plug 8 and a vent 9 are arranged at the top end between the extension rod of the core rod assembly and the extension tube of the large tube. FIG. 1 shows a process flow diagram for manufacturing the fiber preform and the fiber comprising the same. The major parameters of the RIC fiber preforms are shown in Table 1.

TABLE 1
Major parameters of RIC fiber preforms

| | The parameters | | | | | | | |
|---|---|---|---|---|---|---|---|---|
| | of core rod assembly | | | | Small tube | | Large tube | |
| | | a | b | c | OH | | ID | OD |
| ID | Δ (%) | (mm) | (mm) | (mm) | (ppb) | F (%) | (mm) | (mm) |
| 1 | 0.323 | 6.50 | 15.57 | 27.9 | 180 | 0.23 | 29.2 | 100.4 |
| 2 | 0.334 | 10.21 | 21.42 | 26.5 | 26 | 0.35 | 28.1 | 119.8 |
| 3 | 0.329 | 9.41 | 22.92 | 41.5 | 26 | 0.26 | 43.0 | 150.1 |
| 4 | 0.326 | 10.20 | 25.13 | 41.9 | 26 | 0.30 | 43.2 | 149.6 |
| 5 | 0.345 | 9.82 | 25.2 | 42.1 | 26 | 0.27 | 44.1 | 150.2 |
| 6 | 0.326 | 10.82 | 30.18 | 54.2 | 26 | 0.20 | 55.8 | 110.8 |
| 7 | 0.334 | 10.21 | 21.42 | 26.5 | 494 | 0.35 | 30.4 | 149.8 |
| 8 | 0.326 | 9.75 | 23.32 | 41.7 | 320 | 0.24 | 43.0 | 150.0 |

The RIC fiber preform can be directly drawn into fibers and coated with materials for single-mode fibers. The drawing speed is 1500 m/min and the major parameters of drawn fibers are shown in Table. 2.

TABLE 2
Major parameters of fibers

| | Bare fiber | Mode field | Cut-off | | | | | Core/cladding | Additional bending losses | |
|---|---|---|---|---|---|---|---|---|---|---|
| | diameter | diameter | wavelength | Attenuation (dB/km) | | | | concentricity | at 1625 nm (dB/circle) | |
| ID | (μm) | (μm) | (nm) | 1310 nm | 1383 nm | 1550 nm | 1625 nm | error (μm) | Φ20 mm | Φ15 mm |
| 1 | 124.8 | 8.91 | 1258 | 0.330 | 0.312 | 0.194 | 0.206 | 0.14 | 0.04 | 0.11 |
| 2 | 100.1 | 9.15 | 1276 | 0.334 | 0.305 | 0.196 | 0.205 | 0.21 | 0.17 | 0.36 |
| 3 | 125.0 | 8.73 | 1243 | 0.333 | 0.294 | 0.194 | 0.206 | 0.09 | 0.06 | 0.17 |
| 4 | 125.0 | 9.20 | 1308 | 0.328 | 0.291 | 0.191 | 0.201 | 0.12 | 0.09 | 0.18 |
| 5 | 125.0 | 8.81 | 1289 | 0.330 | 0.307 | 0.190 | 0.191 | 0.17 | 0.04 | 0.10 |
| 6 | 79.9 | 8.67 | 1226 | 0.333 | 0.289 | 0.192 | 0.199 | 0.12 | 0.10 | 0.16 |
| 7 | 125.0 | 9.16 | 1272 | 0.333 | 0.342 | 0.194 | 0.207 | 0.24 | 0.17 | 0.36 |
| 8 | 125.0 | 8.97 | 1265 | 0.334 | 0.328 | 0.196 | 0.205 | 0.16 | 0.04 | 0.10 |

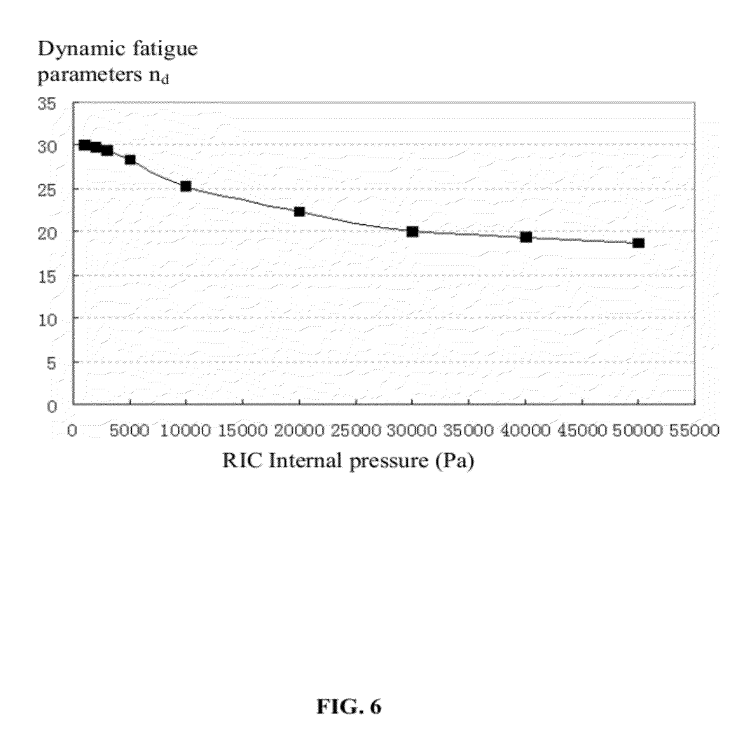

The results show that the G.652.D and G.657 fiber preforms and fibers can be manufactured in accordance with the invention. It should be noted that the gap between the core rod assembly and the large tube shall be vacuumized to be within 10,000 pa to avoid the occurrence of defects on the interface therebetween. As to anti-bending fibers, it is especially important to control the inner defects of fibers. According to IEC 60793-1-33, the anti-fatigue parameter n_{d} of the fibers can be measured by the “bending-at-two points” method. For the same preform, the same drawing process and coating materials are used, and the relationship between RIC inner pressure and the dynamic fatigue parameter n_{d} is shown in FIG. 6, which shows the higher the RIC inner vacuum degree, the higher the dynamic fatigue parameter n_{d}; the wall thickness of the large tube is required to be more than or equal to 30 mm, or otherwise it is hard to maintain an even shrinkage of the large tube in order to maintain the circular degree thereof.

### Example 2

A G.652 mother core rod with a low water peak is manufactured by a VAD process and drawn using a H₂/O₂ flame into a RIC core rod with a desired diameter and then corroded by hydrofluoric acid (HF) on its surface to yield a core rod with an intended diameter. Following example 1, a small tube and a core rod assembly are manufactured. Thereafter, a RIC preform is assembled by a large quartz tube (OD: 200 mm and ID: 53 mm). Major parameters of the core rod assembly are shown in Table 3.

TABLE 3
Major parameters of core rod assembly

| | | | | The parameters of drawn core rod | | | | | | |
|---|---|---|---|---|---|---|---|---|---|---|
| | VAD mother core rod | | | | b′-before | b-after | Small tube | | | |
| ID | Δ (%) | ID (mm) | OD (mm) | a (mm) | corrosion (mm) | corrosion (mm) | OH (ppb) | F (%) | ID (mm) | OD (mm) |
| 9 | 0.344 | 16.25 | 66.20 | 12.81 | 52.14 | 32.15 | 35 | 0.28 | 36.0 | 54.5 |
| 10 | 0.346 | 22.12 | 90.10 | 12.53 | 50.92 | 32.82 | 35 | 0.28 | 36.0 | 54.5 |

The core rod assembly is melted together with the large tube in a tower for stretching, stretched into a small-sized solid preform (OD: 80 mm), and then drawn into fibers. The coating material is the one designed for single-mode fibers. The drawing speed is 1,500 m/m. The bare fiber has a diameter of 124-126 μm, and the main parameters as to the drawn fibers are shown in Table 4.

TABLE 4
Major parameters of fibers

| | Mode field | Cut-off | | | | | Core/cladding | Additional bending losses | |
|---|---|---|---|---|---|---|---|---|---|
| | diameter | wavelength | Attenuation (dB/km) | | | | concentricity | at 1625 nm (dB/circle) | |
| ID | (μm) | (nm) | 1310 nm | 1383 nm | 1550 nm | 1625 nm | error (μm) | Φ20 mm | Φ15 mm |
| 9 | 9.12 | 1263 | 0.327 | 0.271 | 0.187 | 0.195 | 0.11 | 0.14 | 0.36 |
| 10 | 9.05 | 1248 | 0.326 | 0.275 | 0.188 | 0.196 | 0.09 | 0.13 | 0.34 |

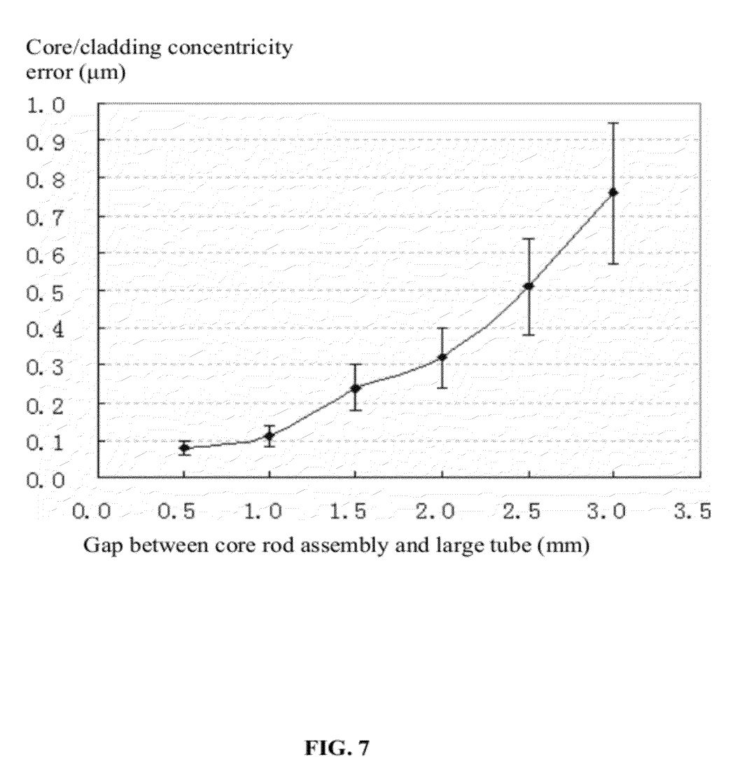

The test shows that ITU-T G.652.D and G.657 fibers can be manufactured in accordance with invention by using the VAD core rod. In the test, the VAD mother core rod, after being drawn, has an outer diameter large enough to replace the core rod assembly. Thus, the quartz tubes (OD: 200 mm and ID: 53 mm) and the VAD mother core rod can be assembled into a RIC preform and different gaps can be obtained by using different amounts of HF for corrosion. The core rod assembly can be melted together with the large tube on a tower for stretching and stretched into small-sized solid preforms (OD: 80 mm) and then drawn into fibers. The relationship between the gap (between the core rod assembly and the large tube) and the core/cladding concentricity of the drawn fibers is shown in FIG. 7. To control the core/cladding concentricity error within 0.54 μm, the gap between the core rod assembly and the large tube shall be controlled less than or equal to 2 mm, more preferably, less than or equal to 1.5 mm.

### Example 3

During a VAD or OVD process for manufacturing an outer cladding layer, due to the involvement of a H₂/O₂ flame, OH pollution will occur to a core rod. As to the plasma jetting technology, the OH content in glass deposits is high, and OH in the environment can be adsorbed on a target rod and then spread inwards. Once OH reaches a core layer of a fiber preform, the water peak will increase. Whether OH can reach the core layer of the fiber preform mainly depends on the spread distance and spread coefficient. One method to increase the spread distance is to increase the c/a value of a core rod, which will increase the production costs accordingly. The fluorine-doped quartz can efficiently prevent external hydroxyl from spreading into the core layer. Related reaction equation is as follows:

$$\begin{matrix}Si - F \\ Si - F\end{matrix} + {H}_{2} O \to \begin{matrix}Si \\ Si\end{matrix} > O + 2 HF$$

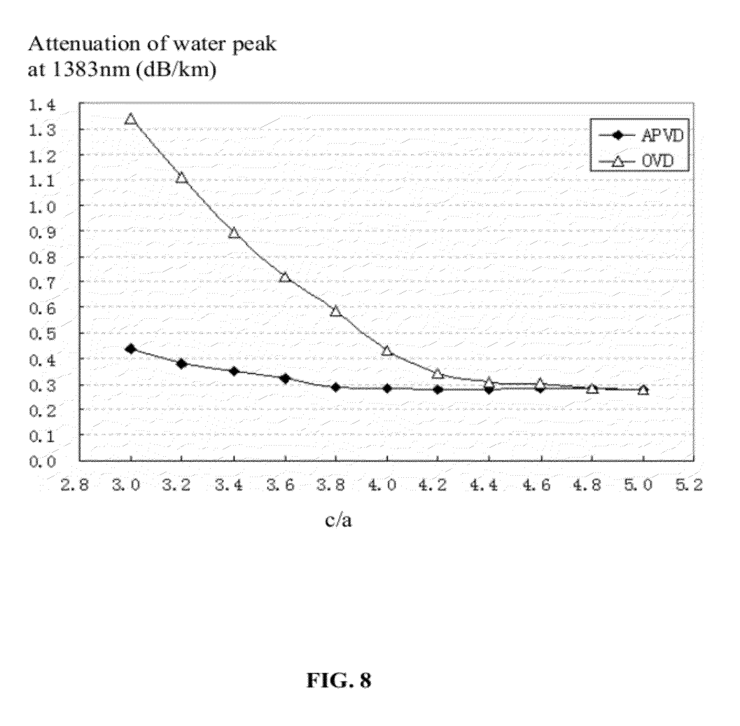

The core rod assembly No. 5 as described in example 1 is employed and the outer diameter of the small fluorine-doped tube is increased to assemble a core rod with an outer diameter c of 50 mm. The obtained core rod assembly is immersed into HF for corrosion on its surface. The lifting speed of the core rod assembly is controlled to obtain continuously varying corrosion amounts on the same core rod assembly as well as to make the outer diameter c of the core rod assembly continuously vary from 29 mm (c/a=2.97) to 50 mm (c/a=5.13). Outer cladding layers are manufactured using an OVD and APVD process, respectively, to form fiber preforms with OD of 15-150 mm. The fiber preforms are drawn into fibers. The bare fibers have a diameter of 124-126 μm. FIG. 8 is a relationship curve for c/a of the core rod assembly and the attenuation of the water peak of the fibers. In accordance with the invention, ITU-T G.652.D and G.657 fiber preforms and fibers can be obtained when an outer cladding layer is made by an OVD or APVD process. Since the VAD process has the same working principles as the OVD process, if a VAD or OVD process is applied, the c/a of the core rod assembly is required to be more than or equal to 4.2; if an APVD process applied, the c/a of the core rod assembly is required to be more than or equal to 3.5.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A fiber preform, comprising: a fiber core rod with a low water peak, and an outer cladding layer; wherein
a ratio (b/a) of a diameter of the fiber core rod to a diameter of a core layer thereof is 2.1-2.8;
the fiber core rod is covered by a small fluorine-doped quartz glass tube and the two are melted together to form a core rod assembly;
a ratio ((c−b)/a) of a diameter difference between the core rod assembly and the fiber core rod to the diameter of the core layer is 0.5-2.2;
a relative refractive index difference of the fluorine-doped quartz glass tube relative to purified quartz glass Δ_{F} is −0.20% to −0.35%, and the content of hydroxyl thereof is less than or equal to 500 ppb;
the core rod assembly is arranged with a large purified quartz glass tube using a RIC process, or directly deposited with a SiO₂ glass cladding layer; and
a ratio (d/c) of an effective diameter of the fiber preform to the diameter of the core rod assembly is 2.0-5.6.

2. A method for manufacturing a fiber preform, comprising:
a) Manufacturing a fiber core rod with a low water peak, a ratio (b/a) of a diameter of the fiber core rod to a diameter of a core layer thereof being 2.1-2.8;
b) Manufacturing a small fluorine-doped quartz glass tube, a relative refractive index difference of the fluorine-doped quartz glass tube relative to purified quartz glass (Δ_{F}) being from −0.20% to −0.35%, and the content of hydroxyl thereof being less than or equal to 500 ppb;
c) Inserting one or more segments of the fiber core rod into the small fluorine-doped quartz glass tube and melting the two together to yield a core rod assembly, a ratio ((c−b)/a) of a diameter difference between the core rod assembly and the fiber core rod to the diameter of the core layer being 0.5-2.2; and
d) Assembling the core rod assembly with a large purified quartz glass tube using a RIC process, or directly depositing a SiO₂ glass cladding layer onto the core rod assembly to yield a fiber preform, a ratio (d/c) of an effective diameter of the fiber preform to the diameter of the core rod assembly being 2.0-5.6.

3. The method of claim 2, wherein the fiber core rod with a low water peak is a single-mode fiber core rod with a low water peak.

4. The method of claim 2, wherein the diameter (a) of the core layer of the fiber core rod is 6-14 mm.

5. The method of claim 3, wherein the diameter (a) of the core layer of the fiber core rod is 6-14 mm.

6. The method of claim 2, wherein the small fluorine-doped purified quartz glass tube is made using an OVD or VAD process, and the content of hydroxyl thereof is less than or equal to 50 ppb.

7. The method of claim 3, wherein the small fluorine-doped purified quartz glass tube is made using an OVD or VAD process, and the content of hydroxyl thereof is less than or equal to 50 ppb.

8. The method of claim 2, wherein the core rod assembly has a bow less than or equal to 2 mm/m.

9. The method of claim 3, wherein the core rod assembly has a bow less than or equal to 2 mm/m.

10. The method of claim 2, wherein a surface of the core rod assembly is corroded by hydrofluoric acid with a corrosion thickness of 0.5-1.0 mm.

11. The method of claim 3, wherein a surface of the core rod assembly is corroded by hydrofluoric acid with a corrosion thickness of 0.5-1.0 mm.

12. The method of claim 2, wherein during the RIC process, a wall thickness of the large purified quartz glass tube is more than or equal to 30 mm; the core rod assembly is fixed in the center of the large tube and concentric with the large tube, and a gap formed between the core rod assembly and an inner hole of the large tube is less than or equal to 2 mm.

13. The method of claim 3, wherein during the RIC process, a wall thickness of the large purified quartz glass tube is more than or equal to 30 mm; the core rod assembly is fixed in the center of the large tube and concentric with the large tube, and a gap formed between the core rod assembly and an inner hole of the large tube is less than or equal to 2 mm.

14. The method of claim 2, wherein a process for directly depositing of the SiO₂ glass cladding layer comprises an OVD process, VAD process, or APVD process; with respect to the VAD or OVD process, a ratio (c/a) of the core rod assembly diameter to the core layer diameter is more than or equal to 4.2; and with respect to the APVD method, the ratio (c/a) of the core rod assembly diameter to the core layer diameter is more than or equal to 3.5.

15. The method of claim 3, wherein a process for directly depositing of the SiO₂ glass cladding layer comprises an OVD process, VAD process, or APVD process; with respect to the VAD or OVD process, a ratio (c/a) of the core rod assembly diameter to the core layer diameter is more than or equal to 4.2; and with respect to the APVD method, the ratio (c/a) of the core rod assembly diameter to the core layer diameter is more than or equal to 3.5.

16. The method of claim 2, wherein the fiber preform before being drawn has a diameter of 100-200 mm.

17. The method of claim 3, wherein the fiber preform before being drawn has a diameter of 100-200 mm.

18. The method of claim 2, wherein for the fiber preform manufactured using the RIC process, the large purified quartz glass tube and the core rod assembly are melted and stretched by means of a tower for stretching to form the fiber preform, and during the melting and stretching a gap between the core rod assembly and the large tube is vacuumized to maintain an internal pressure of 1,000-10,000 Pa.

19. The method of claim 2, wherein for the fiber preform manufactured using the RIC process, the fiber preform is drawn by means of a fiber drawing furnace to yield a fiber, and during the drawing a gap between the core rod assembly and the large tube is vacuumized to maintain an internal pressure of 1,000-10,000 Pa.

20. A single-mode fiber, being manufactured by directly drawing the fiber preform of claim 1 or by stretching and drawing the fiber preform of claim 1.
